(19) United States
(12) Patent Application Publication
(10) Pub. No.: US 2004/0244016 A1
(43) Pub. Date: Dec. 2, 2004

(54) Optical pickup head, optical pickup head manufacturing method, and optical pickup device

(75) Inventor: Hirofumi Sakurai, Fukaya-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/798,445

(22) Filed: Mar. 12, 2004

(30) Foreign Application Priority Data
May 30, 2003 (JP) 2003-155932

(51) Int. Cl. G11B 33/02

(52) U.S. Cl. 720/601

(57) ABSTRACT

An optical pickup head includes a base section, a first board which is provided on the base section and has a first wiring pattern, a second board which is provided on the base section at an angle different from that of the first board and has a second wiring pattern electrically connected to the first wiring pattern, and a flexible section which is formed on at least one of the first and second boards and to which a part of the wiring pattern is extended, the wiring pattern of the first board and the wiring pattern of the second board being soldered to each other via the wiring pattern extended to the flexible section.

### CROSS-REFERENCE TO RELATED APPLICATIONS

This application is based upon and claims the benefit of priority from prior Japanese Patent Application No. 2003-155932, filed May 30, 2003, the entire contents of which are incorporated herein by reference.

### BACKGROUND OF THE INVENTION

1. Field of the Invention

This invention relates to an optical pickup head, an optical pickup head manufacturing method, and an optical pickup device. An optical pickup head is used as an optical read/write device for a DVD (Digital Versatile Disk) unit or a CD-ROM. More particularly, this invention relates to an improvement in the soldered connections in devices of this type and an improvement in the board fixing structure.

2. Description of the Related Art

An optical pickup head is used as an optical read/write device for a DVD unit or a CD-ROM. This type of device has a base section and a plurality of printed-circuit boards fixed to the base section. The individual printed-circuit boards have to be connected to one another electrically. To prevent the positional shift of each board due to rotation, the board is fixed to the base section at two points with two screws. Making the number of screws as small as possible enhances size and cost reduction. Techniques of this type have been disclosed in Jpn. Pat. Appln. KOKAI Publication 9-320092 (hereinafter, referred to as reference 1) and in Jpn. Pat. Appln. KOKAI Publication 8-124200 (hereinafter, referred to as reference 2).

The optical pickup written in reference 1 is such that two flexible printed-circuit boards 53, 62 are provided so as to cross each other almost at right angles, thereby increasing the workability of soldering in the narrow areas on the flexible printed-circuit boards. In the optical pickup written in reference 1, the two flexible printed-circuit boards 53, 62 are fixed in place via only the soldered parts. Therefore, if external forces are applied in the manufacturing processes, the forces will be transmitted directly to the soldered bridge parts, with the result that the land parts might be damaged or cracks might develop in the soldered connections.

The optical pickup written in reference 2 is such that at least one of the engaging parts of the reinforcing plate and slide base which engage with each other engages elastically, thereby making a fixing part unnecessary. However, reference 2 has disclosed a structure useful in fixing a single printed-circuit board to the slide base (or the base section), taking no account of a plurality of boards and the electrical connection between them.

As described above, in the existing optical pickups, many screws are used to fix printed-circuit boards. Therefore, reducing the number of screws will possibly cut costs. In optical pickups of this type, forces are liable to be exerted on the connections between the boards. In this situation, when a load is applied to the soldered bridge part, cracks might develop in the bridge part.

### BRIEF SUMMARY OF THE INVENTION

According to an aspect of the present invention, there is provided an optical pickup head comprises a base section; a first board which is provided on the base section and has a first wiring pattern; a second board which is provided on the base section at an angle different from that of the first board and has a second wiring pattern electrically connected to the first wiring pattern; and a flexible section which is formed on at least one of the first and second boards and to which a part of the wiring pattern is extended, the wiring pattern of the first board and the wiring pattern of the second board being soldered to each other via the wiring pattern extended to the flexible section.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows an outward appearance of an image output apparatus including an optical pickup head according to an embodiment of the present invention;

FIG. 2 is a perspective view of the image output apparatus 100 of FIG. 1, with parts broken away and in section to show the configuration in more detail;

FIG. 3 is a top view of the image output apparatus 100 of FIG. 2, with parts broken away;

FIG. 4 is a plan view of the disk loading section 400 of FIGS. 2 and 3, when viewed from above;

FIG. 5 is a back view of the disk loading section 400 of FIGS. 2 and 3, when viewed from the back;

FIG. 6 is a plan view of the chassis 23, when viewed from above in FIG. 4;

FIG. 7 is a perspective view of the optical pickup head 32 of FIG. 6;

FIG. 8 is an enlarged view of a part of the glass epoxy board 4 of FIG. 7;

FIG. 9 is an enlarged view of a part of the flexible board 5 of FIG. 7;

FIG. 10 is an enlarged view of the end of the flexible cable 5c of FIG. 9;

FIG. 11 is a schematic diagram to help explain the way the glass epoxy board 4 and the flexible board 5 are connected to each other;

FIG. 12 schematically shows an image-related unit to which the present invention can be applied; and

FIG. 13 schematically shows another example of an image-related unit to which the invention can be applied.

### DETAILED DESCRIPTION OF THE INVENTION

Hereinafter, referring to the accompanying drawings, an embodiment of the present invention will be explained in detail.

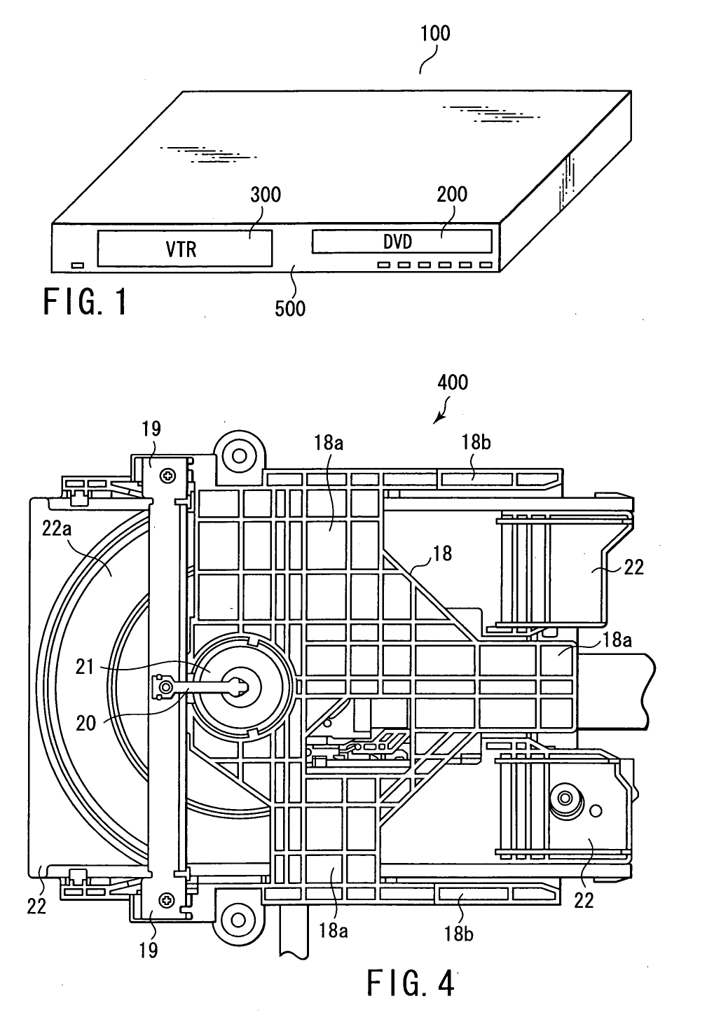

FIG. 1 shows an outward appearance of an image output apparatus including an optical pickup head according to the present invention. The image output apparatus 100, which is connected to an external input of a projection display or the like, is realized as a component for a DVD section 200 and a VTR (Video Tape Recorder) section 300. The DVD section 200 deals with a disk medium. The VTR section 300 handles a tape medium.

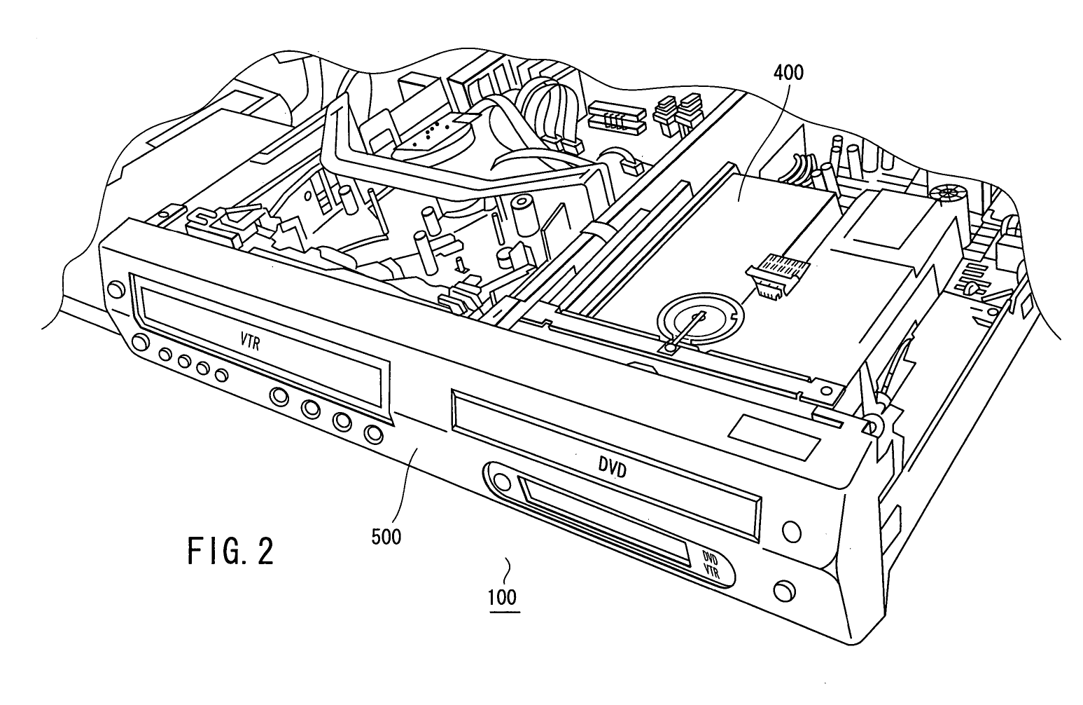

FIG. 2 is a perspective view of the image output apparatus 100 of FIG. 1, with parts broken away and in section to show the configuration in more detail. As shown in FIG. 2, the DVD section includes a disk loading section 400. The disk loading section 400 allows a disk medium to be inserted into and removed and from its housing by a so-called front loading system. The disk loading section 400 includes an optical pickup head, a tray section, and a motor in an integral manner. The optical pickup head is used to read information from a disk medium or write information onto a disk medium. A disk medium is put on the tray section. The motor causes the tray section to move with respect to the housing of the apparatus.

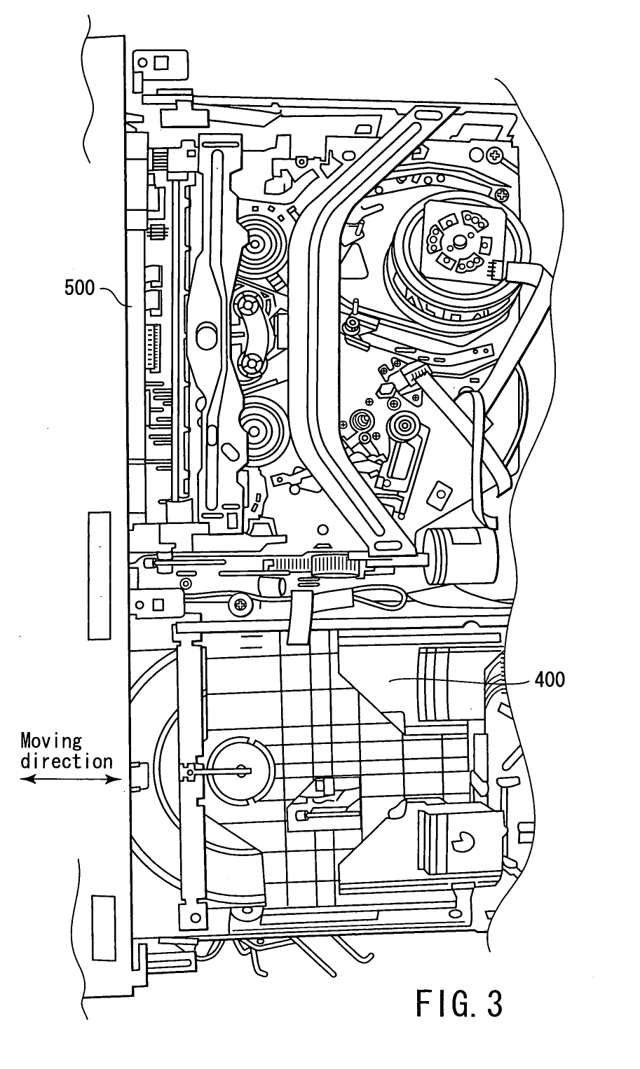

FIG. 3 is a top view of the image output apparatus 100 of FIG. 2, with parts broken away. The disk loading section 400 moves the tray section with respect to a front panel 500 in the direction shown by the arrow.

FIG. 4 is a plan view of the disk loading section 400 of FIGS. 2 and 3, when viewed from above. In FIG. 4, numeral 18 indicates a base body made of resin. The base body 18 has a top panel 18a and a pair of side panels 18b, 18b. The side panels 18b and 18b are connected to each other with a metallic connecting plate 19. A clamp member 21 to clamp a disk medium put on a turntable (explained later) is provided in the middle part of the connecting plate 19 with an elastic mounting strip 20. The clamp member 21 is deformed elastically so as to lie in an opening made in the top panel 18a of the base body 18 and inside the base body 18.

Numeral 22 indicates the tray section. The tray section 22 is provided with a holding section 22a for holding a disk medium. The tray section 22 is held on the bottom plate of the base body 18 in such a manner that it can move freely between the state where it is housed in the base body 18 and the state where it is removed from the base body 18.

FIG. 5 is a back view of the disk loading section 400 of FIGS. 2 and 3, when viewed from the back. In FIG. 5, a chassis 23 whose plane shape is almost rectangular and in which the pickup is installed is supported by the bottom plate 18c in such a manner that it can rock freely, with projections 23a, 23a provided at both ends of one short edge of the chassis 23 as fulcrums. A boss 23b connected to a lift mechanism with a slide cam is provided in the middle part of the other short edge of the chassis 23. The chassis 23 is driven by the lift mechanism in such a manner that the edge on which the boss 23b is provided goes up and down with respect to the base body 18.

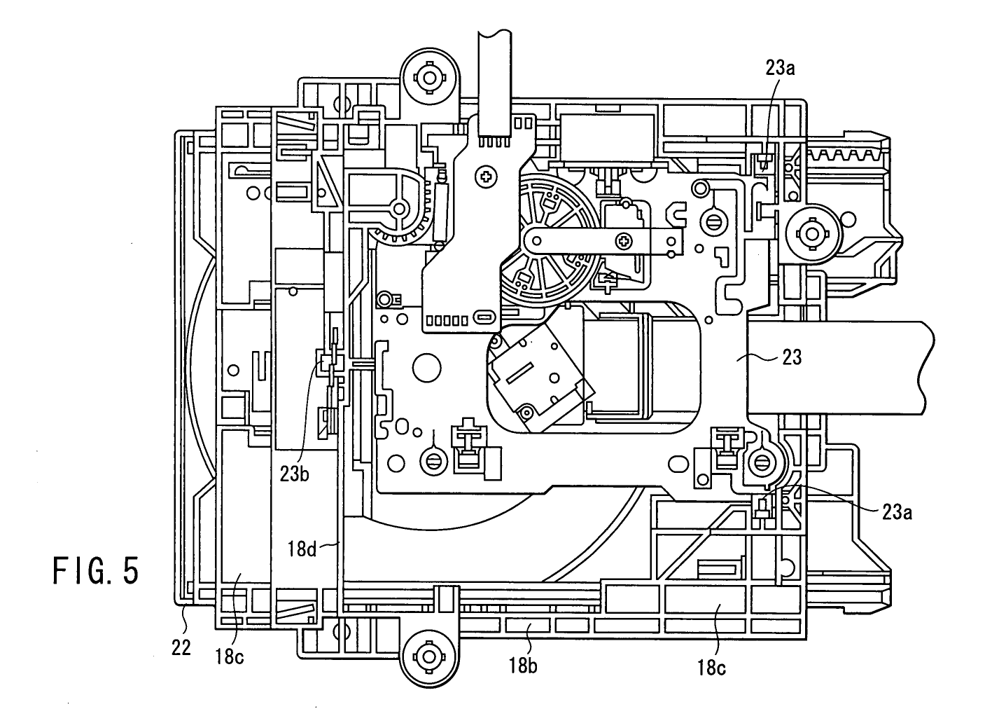

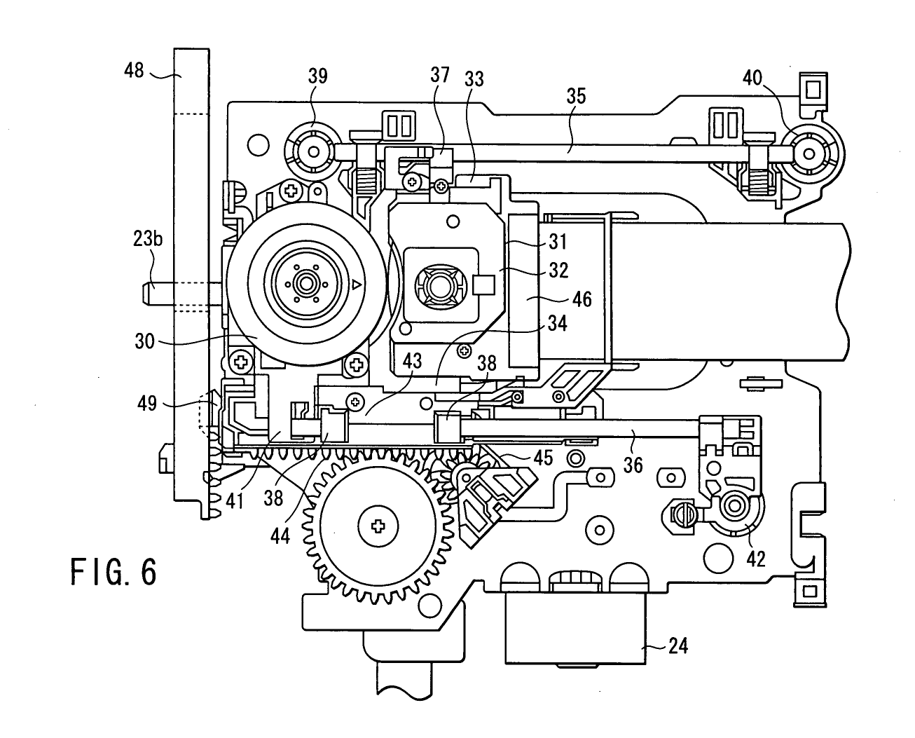

FIG. 6 is a plan view of the chassis 23, when viewed from above in FIG. 4. In FIG. 6, numeral 30 indicates a turntable, which is fixed to the axis of rotation of a disk medium driving motor (not shown) fixed to the chassis 23. The chassis 23 includes an optical pickup 31. The optical pickup 31 has an optical pickup head 32, a printed-circuit board 33, and an optical base 34. The optical pickup head 32 includes a laser diode and a photodiode. The optical pickup head 32 is provided on the printed-circuit board 33. The printed-circuit board 33 is fixed to the optical base 34.

The optical pickup 31 is supported by two guide shafts 35, 36 provided on the chassis 23 in such a manner that it can slide freely in a direction to get closer to the turntable 30 and in a direction to separate from the turntable 30. To do this, holding members 37, 38 engaged with the guide shafts 35, 36 so as to rock freely are provided on the optical base 34. The optical pickup 31 is provided on the guide shafts 35, 36 by the holding members 37, 38 in such a manner that the pickup can slide freely.

The guide shafts 35, 36 are supported by support members 39, 40, 41, 42 with respect to the chassis 23. Of the four support members 39 to 42, for example, three members (39, 40, 42) are provided with adjusting mechanisms capable of adjusting the distance between the guide shafts 35, 36 and the face of the chassis 23. The adjusting mechanism makes tilt adjustments of the optical pickup 31.

Two units of the holding member 38 engaged with the guide shaft 36 are provided a specific distance apart along the axis of the guide shaft 36. A rack member 43 formed so as to enclose the holding member 38 is fixed to the optical base 34 of the optical pickup 31. On the side opposite to the optical pickup 31 of the rack member 43, a rack 44 is formed. A pinion gear 45 is engaged with the rack 44. The rotation of the driving motor is transmitted to the rack 44. As a result, while being held by the guide shafts 35, 36, the optical pickup 31 is moved in the direction corresponding to the direction of the rotation of the driving motor. In the rack member 43, a cam driving section 49 for driving a slide cam 48 toward the tip of the axis of the guide shaft 36 is formed.

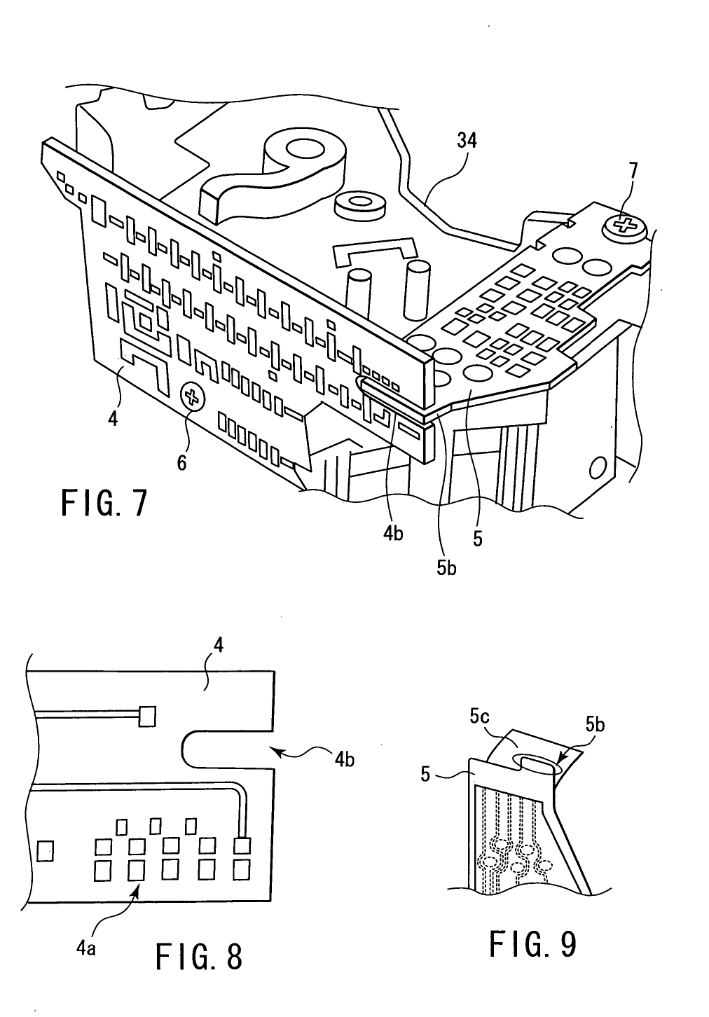

FIG. 7 is a perspective view of the optical pickup head 32 of FIG. 6. In FIG. 7, numeral 4 indicates a glass epoxy board, which is fixed at one point to the optical base 34 with a screw 6. Numeral 5 is a flexible board, which is fixed at one point to the optical base 34 with a screw 7 so as to cross the glass epoxy board 4 at right angles. The glass epoxy board 4 is provided so as to be perpendicular to the optical base 34. The flexible board 5 is provided so as to be parallel with the optical base 34. Therefore, the relative positional relationship between the glass epoxy board 4 and flexible board 5 is such that they cross each other at right angles.

The glass epoxy board 4 has a concave part 4b. On the other hand, the flexible board 5 has a convex part 5b. They are combined with each other in such a manner that the convex part 5b of the flexible board 5 is mated with the concave part 4b of the glass epoxy board 4, which aligns the glass epoxy board 4 and flexible board 5 with each other.

FIG. 8 is an enlarged view of a part of the glass epoxy board 4 of FIG. 7. For example, on the back of the glass epoxy board 4, a wiring pattern 4a for transmitting an electric signal is formed. A part of the lands (copper foil parts) which enable soldering connections are exposed. Then, a cutout concave section 4b is formed in the position where the glass epoxy board 4 is combined with the flexible board 5.

FIG. 9 is an enlarged view of a part of the flexible board 5 of FIG. 7. The flexible board 5 is formed by laminating a flexible electric wiring section to a hard member, such as glass epoxy, with adhesive. The flexible electric wiring section is bendable. A wiring pattern for transmitting an electric signal is printed on the flexible electric wiring section.

In the embodiment, the flexible electric wiring section is laminated to the hard member, with a strip-like part of the wiring section being left as it is. That is, not all of the flexible electric wiring section is laminated to the hard member. Specifically, a part of the hard member and flexible electric wiring section are branched. The branched part makes a flexible cable 5c, which is bendable.

Furthermore, on the flexible board 5 (or hard member), a convex part 5b is formed in the position where the flexible board 5 is combined with the glass epoxy board 4. The convex part 5b has a hardness corresponding to the material of the hard member.

FIG. 10 is an enlarged view of the end of the flexible cable 5c of FIG. 9. As shown in FIG. 10, the wiring pattern of the flexible electric wiring section is extended as far as the flexible cable 5c. The end of the flexible cable is provided with terminals, thereby forming a signal transmission section for soldering the wiring pattern 4a of the glass epoxy board 4 to the wiring pattern of the flexible electric wiring section with each other.

FIG. 11 is a schematic diagram to help explain the way the glass epoxy board 4 and the flexible board 5 are connected to each other. In the state where the glass epoxy board 4 and flexible board 5 are aligned with each other, the flexible cable 5c is flexed with respect to the glass epoxy board 4, with the result that the signal transmission section 5c adheres to the lands of the glass epoxy board 4. Soldering the parts causes the wiring pattern 4a of the glass epoxy board 4 to be connected to the wiring pattern of the flexible board 5 electrically.

In the embodiment, the concave part 4b is formed on the glass epoxy board 4 and the convex part 5b is formed on the flexible board 5. Mating the concave part 4b and convex part 5b with each other causes the glass epoxy board 4 and flexible board 5 to be aligned with each other. Furthermore, in the flexible board 5, a part of the flexible member on which the wiring pattern is printed is branched, thereby forming the flexible cable 5c. Then, the wiring pattern of the flexible board 5 is extended as far as the flexible cable 5c and then printed. The resulting pattern is soldered to the wiring pattern 4a of the glass epoxy board 4 via the signal transmission section 5c.

In this way, the glass epoxy board 4 and flexible board 5 are fixed in position even at the mated part. That is, not only can the strength with which the glass epoxy board 4 and flexible board 5 are provided to the optical base 34 be increased, but also it is possible to limit the range in which the flexible board 5 can move in the vertical and horizontal directions with respect to the optical base 34. Therefore, the glass epoxy board 4 and flexible board 5 can be fixed to the optical base 34 at one point with screws 6, 7, respectively. Consequently, while in the existing optical pickup head, at least two screws are needed for a single board, the number of screws can be halved in the embodiment, which helps simplify the manufacturing procedure and reduce costs.

Furthermore, the flexible board 5 is soldered to the glass epoxy board 4 via the flexible cable 5. As a result, a mechanical margin of the flexible cable 5c buffers the stress even when the glass epoxy board 4 and flexible board 5 are shifted in position with respect to the optical base 34 during the manufacturing work including the mounting process and at the time of installation. That is, the forces applied to the soldered connections are buffered. Accordingly, even during the work of soldering the electric signal transmitting section or in handling products, the possibility of solder cracks or poor contact is eliminated.

The present invention is not limited to the above embodiment. For instance, a convex part may be formed on the glass epoxy board 4 and a concave part may be formed on the flexible board 5. In short, making them mate with each other produces the effect of reducing the number of screws. Furthermore, the glass epoxy board 4 and flexible board 5 may be fixed to the optical base 34 with adhesive.

In addition, the present invention can be applied not only to an image output apparatus as shown in FIG. 1 but also to another electrical appliance.

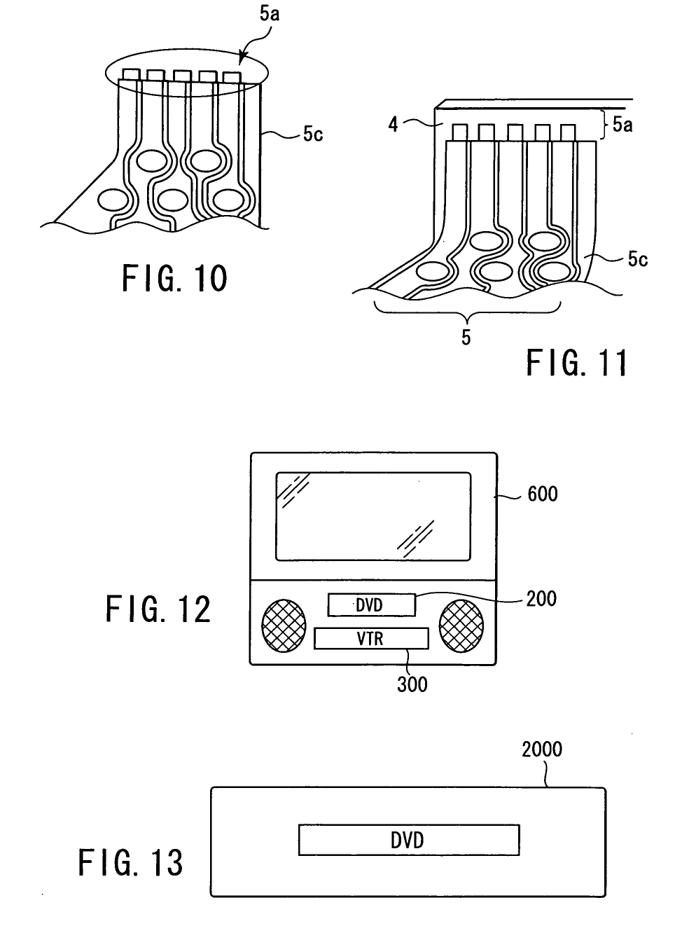

FIG. 12 schematically shows an image-related unit to which the present invention can be applied. The unit is obtained by combining a television set including a display section 600 for displaying images with a DVD section 200 and a VTR section 300. Even in this unit, the present invention can be applied to the optical pickup section of the DVD section 200.

FIG. 13 schematically shows another example of an image-related unit to which the invention can be applied. As shown in FIG. 13, the invention can, of course, be applied to a single DVD unit.

To summarize what has been described above, with the present invention, the first and second boards are soldered to each other via the flexible section. As a result, even when forces are applied to the connections, the deformation of the flexible part prevents significant stress from being applied to the soldered connections, which prevents poor contact from being made.

As described above in detail, with the present invention, it is possible to provide an optical pickup head, an optical pickup head manufacturing method, and an optical pickup device which not only prevent a load from being applied on the soldered connections and but also reduce costs.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical pickup head comprising:
a base section;
a first board which is provided on the base section and has a first wiring pattern;
a second board which is provided on the base section at an angle different from that of the first board and has a second wiring pattern electrically connected to the first wiring pattern; and
a flexible section which is formed on at least one of the first and second boards and to which a part of the wiring pattern is extended, the wiring pattern of the first board and the wiring pattern of the second board being soldered to each other via the wiring pattern extended to the flexible section.

2. The optical pickup head according to claim 1, further comprising:
a convex part which is formed on the first board; and
a concave part which is formed on the second board and is mated with the convex part to align the first board and the second board with each other.

3. The optical pickup head according to claim 2, wherein at least one of the first and second boards is fixed to the base section at one point with a fixing screw.

4. The optical pickup head according to claim 1, wherein the board on which the flexible section is formed includes
a hard plate member; and
a flexible wiring section which is bendable and is laminated to the hard plate member with a strip-like part of the flexible wiring section left as it is and on which a wiring pattern of the board is printed, wherein
the flexible section makes the strip-like part of the flexible wiring section.

5. A method of manufacturing an optical pickup head formed by fixing a first board with a first wiring pattern and a second board with a second wiring pattern to a base section, the method comprising:
a first step of forming a convex part on the first board;
a second step of forming a concave part on the second board;
a third step of forming a flexible section to which a part of the wiring pattern is extended, on at least one of the first and second boards;
a fourth step of mating the convex part and the convex part with each other to align the first and second boards with each other; and
a fifth step of soldering the wiring pattern of the first board and the wiring pattern of the second board to each other via the wiring pattern extended to the flexible section.

6. The method according to claim 5, wherein at least one of the first and second boards is fixed to the base section at one point with a fixing screw.

7. The method according to claim 5, wherein the third step includes
a sixth step of laminating a flexible wiring section which is bendable and on which a wiring pattern for the flexible-section-formed is printed, to a hard plate member, with a strip-like part of the flexible wiring section left as it is, wherein
the flexible section makes the strip part of the flexible wiring section.

8. An optical pickup device comprising:
a head section for projecting laser light onto a disk medium via an optical lens; and
a holding section for holding the disk medium so that the disk medium may face the head section,
the head section includes
a base section which includes the optical lens;
a first board which is provided on the base section and has a wiring pattern;
a second board which is provided on the base section at an angle different from that of the first board and has a wiring pattern electrically connected to the wiring pattern of the first board;
a convex part which is formed on the first board;
a concave part which is formed on the second board and mates with the convex part to align the first board and the second board with each other; and
a flexible section which is formed on at least one of the first and second boards and to which a part of the wiring pattern is extended, the wiring pattern of the first board and the wiring pattern of the second board being soldered to each other via the wiring pattern extended to the flexible section.

9. The optical pickup device according to claim 8, wherein at least one of the first and second boards is fixed to the base section at one point with a fixing screw.

10. The optical pickup device according to claim 8, wherein the board on which the flexible section is formed includes
a hard plate member; and
a flexible wiring section which is bendable and is laminated to the hard plate member with a strip-like part of the flexible wiring section left as it is and on which a wiring pattern for the board is printed, wherein
the flexible section makes the strip-like part of the flexible wiring section.
